(19) United States
(12) Patent Application Publication
(10) Pub. No.: US 2008/0015719 A1
(43) Pub. Date: Jan. 17, 2008

(54) Computer-assisted assessment of seat design

(76) Inventors: Scott Ziolek, Ann Arbor, MI (US); Terry O'Bannon, Royal Oak, MI (US); Ash Galbreath, Troy, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(21) Appl. No.: 11/486,500

(22) Filed: Jul. 14, 2006

(51) Int. Cl. G06F 19/00

(52) U.S. Cl. 700/97

(57) ABSTRACT

Method of computer-assisted assessment of seat design. The method being applicable to any number of seating, including but not limited to vehicle seating commonly employed in automobiles, watercraft, aircraft, etc. The method optionally including overlaying a body pressure distribution (BPD) data object relative to an architectural drawing to facilitated assessing pressure distribution relative to component architecture.

### BACKGROUND OF THE INVENTION

1. Field of the Invention

The present invention relates to methods and systems associated with vehicle seat design.

2. Background Art

Vehicle seats include any number of components, such as but not a seat back and seat bottom. The components may include any number of elements, such as but not limited to a frame, cushioning, suspension, etc. The size, shape, feel, orientation, etc., of these and other features of the seat may influence comfort, performance, and other seat amenities.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates a vehicle seat in accordance with one non-limiting aspect of the present invention;

FIG. 2 illustrates the seat back in more detail and in accordance with one non-limiting aspect of the present invention;

FIG. 3 illustrates a body pressure distribution (BPD) diagram for the seat back in accordance with one non-limiting aspect of the present invention;

FIG. 4 illustrates a BPD overlay in accordance with one non-limiting aspect of the present invention;

FIG. 5 illustrates a comparison overlay in accordance with one non-limiting aspect of the present invention; and

FIG. 6 illustrates a flowchart for a method of computer-assisted assessment of a vehicle seat in accordance with one non-limiting aspect of the present invention.

### DETAILED DESCRIPTION OF THE PREFERRED EMBODIMENT(S)

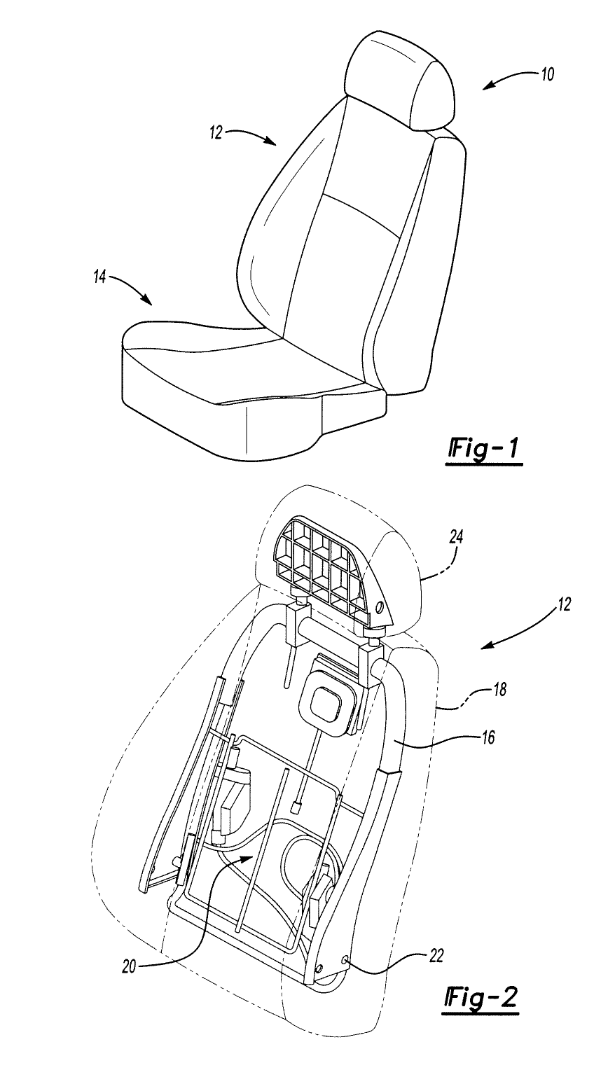

FIG. 1 illustrates a vehicle seat 10 in accordance with one non-limiting aspect of the present invention. The vehicle seat 10 may include any number of features and elements associated with supporting an occupant. The vehicle seat 10 may be suitable for use in any number of environments, including but not limited to automobiles, watercraft, aircraft, boating, childseats, military applications, heavy truck etc.

The vehicle seat 10 may include any number of components, such as but not limited to a seat back 12 and a seat bottom 14. The seat back and bottom may include any number of elements for supporting the occupant and/or other features associated with the seat 10, such as but not limited to a frame, suspension, foam support, lumbar, etc. These and other elements may cooperate to comprise each component 12-14.

FIG. 2 illustrates the seat back 12 in more detail and in accordance with one non-limiting aspect of the present invention. The seat back 12 shown in FIG. 2 is provided for exemplary purposes and without intending to limit the scope and contemplation of the present invention. It includes a number of elements 16-24, including but not limited to a frame 16, cushion (shown in phantom) 18, lumbar system 20, recliner pivot 22, and headrest 24. The illustration of these elements 16-24 and other elements and the interaction of the same may be generally referred to as an infrastructure for the corresponding seat component 12.

The seat elements 16-24 may exert a force against an occupant thereof. The amount of force may depend on any number of variables associated with the elements 16-24 comprising the component 12, including but not limited to their size, shape, feel, positioning, and other controllable aspects. The configuration of the elements may be selected to influence an opinion of the customer with respect to comfort, performance, and other amenities associated with seating quality.

Different manufacturers or manufacturers having different product lines may produce seat components 12-14 with varying levels of comfort, quality, customer satisfaction, etc., depending on the particular elements comprising the components. In come case, the manufacturers may use higher quality or more expensive elements to provide greater comfort and performance and lower quality elements to provide more inexpensive components.

As such, any number of variables may influence the occupant perceived seating quality. One indicator of such seat quality is relative pressure between the occupants and seat components 12-14. Pressure points experienced between the seat components 12-14 and elements with respect to the occupant can greatly influence the occupant's satisfaction with the seat. Pressure at certain locations of the occupant's body may be less desirable than at other locations. Occupants of varying size and shape may perceive such pressures differently.

The design, positioning, dimensioning, material composition, and other controllable features of the component elements can dictate the location and severity of the pressure points. The location and severity of the pressure points may vary from manufacture to manufacture and/or across product lines of the same manufacture, depending on the specifications used to construct the component elements. Secondary information, such as that gleaned from customer surveys, may be used to assess customer satisfaction with the seat, i.e., subjective seat quality.

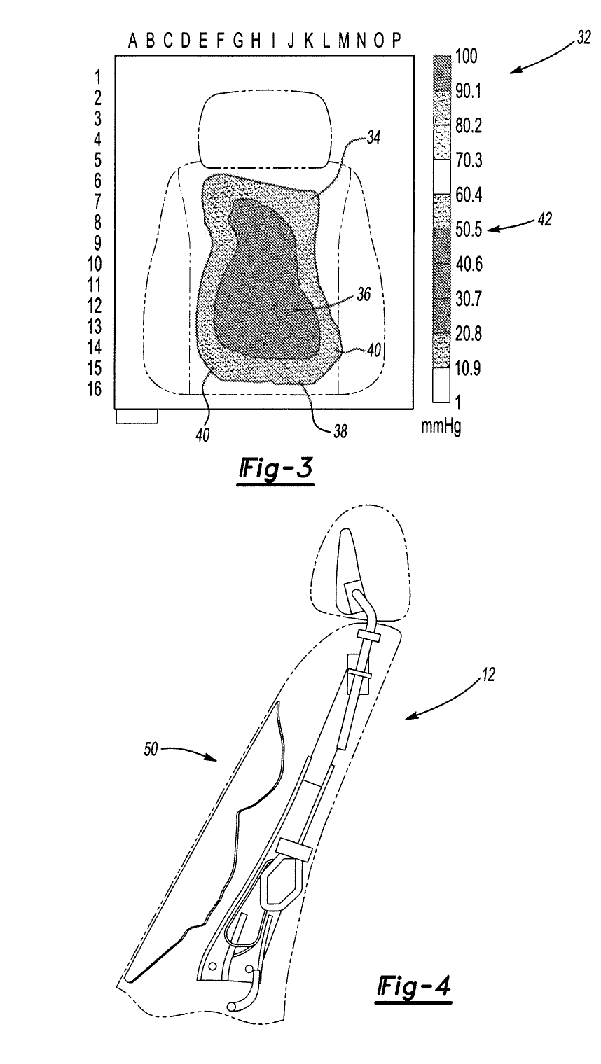

FIG. 3 illustrates a body pressure distribution (BPD) diagram 32 for the seat back 12 in accordance with one non-limiting aspect of the present invention. The BPD diagram 32 displays pressure information for the seat back 12 relative to a dummy, individual, weight, or other element placed against the seat back 12, typically in conjunction with an occupant sitting within the seat 10 such that pressure is exerted against the seat bottom 14 and seat back 12.

The pressures shown in the BPD diagram may be determined through testing measured with one or more sensors (not shown) placed within the seat 10 to sense pressure throughout the seat back 12 and/or at areas of particular interest. The pressures may be sensed at discrete locations or practically throughout the entire component 12, as shown. Highlights or other call outs may be included to identify an upper back 34, lower back (lumbar region) 36, biteline 38, and side (bolster) 40 portions of the exemplary seat back 12.

The pressure values may be graphically displayed with different colors indicating pressure severity and/or through some other display mechanism. A color coded grid 42 may be included to illustrate a pressure value key for the corresponding color scheme. Pressure values, coordinates, and other metrics may be shown or otherwise associated with the pressure readings to facilitate correlating the pressure information with the vehicle seat structure, manufacturer, testing conditions, etc.

Pressure diagrams may be created as a function of particular occupant profiles (size, gender, shape, etc.) in order to obtain pressure information and characteristics for different body profiles and distribution patterns (sparse vs. full, even vs. erose) under static or dynamic conditions. These or other pressure values and parameters may be averaged or otherwise processed in order to normalize the results for a particular seat back vendor/manufacturer.

In this manner, the present invention contemplates creating an electronic database of BPD for any number of seat backs and bottoms and according to any number of manufactures and vendors. The pressure readings may be stored in an electronic form and used in accordance with the present invention to facilitate virtual seat design and testing.

FIG. 4 illustrates a BPD overlay 50 in accordance with one non-limiting aspect of the present invention. The overlay 50 may be an electronic representation of the BPD diagram 32 as converted to a data object suitable for use within a computer aided design (CAD) application having capabilities to position the overlay relative to the seat back elements 16-24. The overlay 50 may be used as a three-dimensional representation of the body pressure relative to the seat back elements 16-24.

In this manner, the present invention is able to graphically depict body pressure relative to the seat back elements 16-24. The overlay data object 50 can be stored electronically and made accessible to CAD designs when designing seat backs 12 or seat bottoms 14. Such information may be useful in graphically illustrating pressure locations against the seat back elements causing the pressure.

Deeper impressions generally correspond with areas of more pressure. Points or other areas surrounded by relatively sharp increases in pressure tend to be areas of sudden increased pressure. The increased pressure may be desirable and/or undesirable, depending on the relative position of the occupant. The desirability of the pressure or pressure points can influence comfort and other variables associated with occupant satisfaction.

The present invention allows designers to easily asses pressure distribution of the seat back/bottom. Characterizing the pressure points with the overlay 50 allows the designers to assess the location of desirable and undesirable pressure points and to assess the elements likely to be causing the localized pressure, which can be helpful in combating pressure issues and providing a more comfortable seat.

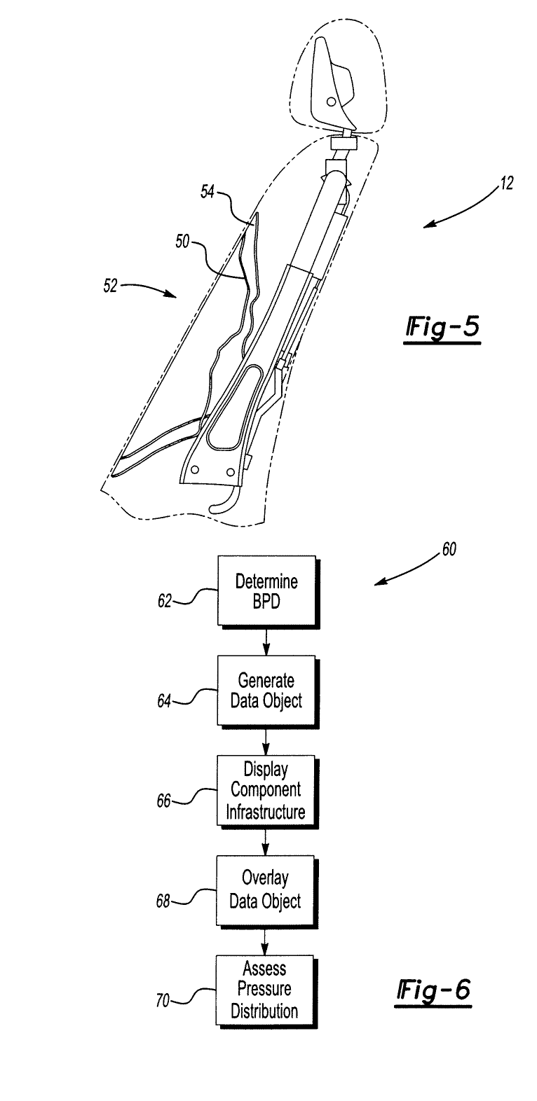

FIG. 5 illustrates a comparison overlay 52 in accordance with one non-limiting aspect of the present invention. The comparison overlay 52 illustrates the overlay 50 of FIG. 4 relative to a secondary overlay 54. The secondary overall may correspond with the overlay of another seat back or other desirable entity. The secondary overlay, for example, may correspond with another seat back manufacturer so that the designer can compare different overlays against the seat design associated the first overlay.

The comparison 52 may be helpful in allowing the designer to asses the elements causing pressure. For example, if the first overlay 50 indicates pressure at locations different from the second overlay 54, the designer may make adjusts to the design based on the design associated with the second overlay 54. Likewise, the second overlay 54 may be associated with an ideal pressure pattern and compared to the first overlay 50 to determine locations where pressure adjustments may need to be made in order to correspond with the ideal pressure pattern.

FIG. 6 illustrates a flowchart 60 for a method of computer-assisted assessment of a vehicle seat in accordance with one non-limiting aspect of the present invention. The method may be embodied in a computer-readable medium or other logically executing element capable of executing the steps and aspect of the present invention with respect to computer-assisted assessment and design.

Block 62 relates to determining a BPD chart, diagram, grid, or other element for a vehicle seat component, such as but not limited to a seat bottom or seat top. The BPD information may be determined as described above or according to another methodology sufficient to determine pressure points, pressure patterns, and other pressure related indicia for the analyzed seat component.

Block 62 may include compiling an electronic database or other information repository for BPD information from any number of seat components and suppliers. Optionally, the BPD information may be tied to an infrastructure, diagram, or other architectural representation or infrastructure related drawing of the associated seat component.

Block 64 relates to generating a BPD data object for one or more sets of BPD data. The BPD data objects may be of the type suitable for use with CAD applications, including but not limited a type sufficient to overlay the data object relative to an infrastructure drawing of the corresponding seat component.

The data objects may be stored in an electronically searchable and accessible database. Multiple BPD data objects may be determined for any number of seat components. Optionally, idealized or desirable data objects may be determined based on preferred, tested, or conceptualized pressure distribution patterns. The BPD objects may be computer renditions of the BPD information in a three-dimensional form.

Block 66 relates to determining a component infrastructure for a component to be assessed. The component infrastructure may relate to a three-dimensional or other drawing of the seat component and its corresponding elements. Optionally, the infrastructure may be selected for to correspond to a selected first one of the overlays and used as a basis for comparison thereto and with other overlays, ad described below in more detail.

Block 68 relates to overlaying one or more of the data objects within the CAD application and against a seat architecture drawing, diagram, file, or other displayed element within the computer application. This may include, for example, illustrating the data object relative to individual elements comprising the seat component, such as but not limited to the seat frame, wiring, suspension, lumbar, supports, etc.

Optionally, multiple data objects may be overlaid relative to the illustrated seat component architecture. For example, different data objects from different product lines or manufactures may be overlaid for a comparison analysis. Optionally, the overlaid images may be animated to illustrate the time-varying changes in pressure and patterns of distribution with events of interest (vibration, activation of lumbar, safety, acoustics, vibration response to optimize durability, craftsmanship and safety, shock protection, etc.).

One of the multiple overlays may be derived/determined for the currently illustrated seat component architecture and the other may be from another architecture such that one of the overlays is associated with the illustrated overlay and the other overlay is associated with a non-illustrated architecture. If the another architecture includes a more desirable pressure distribution pattern, the designer can access the drawings associated with its corresponding architecture so as to assess the element positioning providing the more desirable pressure distribution.

One of the multiple overlays may be derived/determined for an idealized or desired pressure distribution for the seat component. A designer or other entity may determine the desired pressure distribution for a particular occupant profile and comfort characteristics. This profile may then be overlaid relative to the actual pressure profile to locate areas of differential pressure and to assess the seat elements causing the same.

Block 70 relates to assessing the one or more overlaid date objects relative to the seat component architecture. The comparison may be performed by the view subjectively reviewing the overlay(s) against the corresponding architectures and/or through some other objective computer-related processing. In this manner, for example, locations of non-desirable pressure may be highlighted visually by the designer by clicking on the element and/or automatically with shading or other features of the CAD application so as to facilitate assessing the pressure distribution.

As described above, one non-limiting aspect of the present invention relates to a method of converting pressure data collection on benchmark or design seat into a CAD object that can be imported and overlaid onto a produce CAD data. Another non-limiting aspect of the present invention allows analysts and designers to view occupant contact within the same design environment in which they make corrective actions, i.e., the CAD application.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of computer-assisted assessment of vehicle seat design, the method comprising:
displaying a vehicle seat component infrastructure associated with the vehicle seat design within a computer assisted drawing (CAD) application;
importing a body pressure distribution (BPD) data object suitable for use with the CAD application, the BPD object being used to characterize a body pressure distribution (BPD) diagram for the seat component; and
overlaying the BPD data object relative to the vehicle seat component infrastructure in order to assess pressure distribution of the vehicle seat component infrastructure.

2. The method of claim 1 further comprising automatically identifying elements of the seat infrastructure associated with undesirable pressures.

3. The method of claim 2 further comprising highlighting the elements with undesirable pressures within the displayed vehicle seat component infrastructure.

4. The method of claim 1 further comprising determining the BPD data object as a function of pressure readings recorded with pressure sensors positioned within the seat component.

5. The method of claim 1 further comprising determining the BPD data object for the seat component being a seat back.

6. The method of claim 1 further comprising determining the BPD data object for the seat component being a seat bottom.

7. The method of claim 1 further comprising generating a second BPD data object and overlaying both BPD data objects relative to the vehicle seat component infrastructure in order to assess pressure distribution of the vehicle seat component infrastructure.

8. The method of claim 7 further comprising determining the second BPD data object for a desired pressure distribution for the seat component.

9. The method of claim 7 further comprising selecting the second BPD data object from an electronic library of BPD data objects associated with other seat components.

10. A method of computer-assisted assessment of seat design, the method comprising:
displaying a seat component infrastructure associated with the seat design within a computer assisted drawing (CAD) application;
importing multiple body pressure distribution (BPD) data objects suitable for use with the CAD application, the BPD objects being used to characterize a body pressure distribution (BPD) diagrams for the seat component; and
overlaying at least two of the BPD data objects relative to the seat component infrastructure in order to simultaneously assess pressure distribution of the seat component infrastructure with respect to the at least two BPD data objects.

11. The method of claim 10 further comprising associating one of the overlaid BPD data objects with an actual BPD for the seat component.

12. The method of claim 11 further comprising associating at least one other overlaid BPD data object with a desired BPD for the seat component so as to assess the actual pressure distribution against the desired pressure distribution.

13. The method of claim 11 further comprising associating the at least one other overlaid BPD data object with a secondary BPD of another product line associated with the seat component so as to assess the actual pressure distribution against the another product line pressure distribution.

14. The method of claim 10 further comprising automatically identifing elements of the seat infrastructure associated with undesirable pressures.

15. The method of claim 10 further comprising determining the BPD data object as a function of pressure readings recorded with pressure sensors positioned within the seat component.

16. The method of claim 10 further comprising determining the BPD data object for the seat component being a seat back.

17. The method of claim 10 further comprising determining the BPD data object for the seat component being a seat bottom.

18. A vehicle seat component data object suitable for use with a computer assisted drawing (CAD) application, the object comprising:
a characterization of a body pressure distribution (BPD) for the seat component and being suitable for overlay relative to a computer replicated depiction of a vehicle seat component infrastructure associated with the vehicle seat component in order to assess pressure distribution patterns of the vehicle seat component.

19. The object of claim 18 further comprising a second pressure distribution pattern in order to simultaneously assess pressure distribution patterns relative to the vehicle seat component infrastructure.

20. The object of claim 18 further comprising secondary information to facilitate overlaying the data object relative.
